(19) United States
(12) Patent Application Publication
(10) Pub. No.: US 2024/0280957 A1
(43) Pub. Date: Aug. 22, 2024

(54) DEVICE AND METHOD FOR RECOGNISING A SHEET METAL PROCESSING MEANS IN A SHEET METAL PROCESSING MACHINE

(71) Applicant: ARKU MASCHINENBAU GMBH, Baden-Baden (DE)

(72) Inventors: Jacques BURTSCHER, Roeschwoog (FR); Daniel STOLZER, Baden-Baden (DE); Marcel REITH, Sinzheim (DE)

(73) Assignee: ARKU MASCHINENBAU GMBH, Baden-Baden (DE)

(21) Appl. No.: 18/430,306

(22) Filed: Feb. 1, 2024

(30) Foreign Application Priority Data
Feb. 17, 2023 (EP) 23157232.2

(51) Int. Cl. G05B 19/401; G05B 19/404; G05B 19/409; G06K 7/00

(52) U.S. Cl. CPC G05B 19/401; G05B 19/404; G05B 19/409; G06K 7/0008

(57) ABSTRACT

A device for recognising a sheet metal processing means in a sheet metal processing machine includes: an RFID unit for receiving a read signal of an RFID reader with information on an RFID transponder affixed on a sheet metal processing means at a sheet metal processing station in the sheet metal processing machine; an evaluation unit for determining sheet metal processing means data with information on the sheet metal processing means based on the read signal; and a machine interface for controlling a machine system of the sheet metal processing machine based on the sheet metal processing means data.

The present invention relates to a device and a method for recognising a sheet metal processing means in a sheet metal processing machine. The present invention further relates to a system for processing sheet metal, a sheet metal processing means, and an associated computer programme product.

When cutting and punching parts made of sheet steel, the cutting edges and rims of the cut-out apertures and recesses will form unwanted burrs protruding from the top or bottom surface of the steel sheet. In particular, sheet steel parts having a thickness of several centimetres may require a great deal of technical effort to deburr them, i.e. to round the edges and grind the surface.

In this context, DE 20 2020 107 308 U1 discloses a machine for processing sheet metal parts. This machine is designed to process sheet metal parts in several consecutive processing steps. It provides, in particular, deburring, rounding of edges, and grinding of the surface. The machine comprises a machine frame and a transport belt. The transport belt is designed to transport the sheet metal part to be processed in a horizontal direction from a charging table to an output table. The machine further comprises a plurality of processing units which are arranged behind one another along the transport belt in the direction of passage of the sheet metal part. The processing units comprise a brush set having flexible grinding brushes, and at least one grinding belt set having a contact roller arranged transversally with respect to the direction of passage. In addition, the machine comprises an auxiliary frame on which the grinding belt set is mounted and which is supported within the machine frame in such a manner as to be movable in a vertical direction. Finally, the machine comprises a setting device that is arranged between the machine frame and the auxiliary frame and serves for setting the distance between the transport belt and the contact roller of the grinding belt set independently of the other processing stations.

In such sheet metal processing machines, brushes, grinding means, tools, and other sheet metal processing means are employed in various different sheet metal processing stations for processing the metal sheet. In this context, the selection of the suitable and appropriate tools and of the adequate settings for achieving the desired result, on the one hand, and the initial checking and ongoing monitoring of whether the sheet metal processing means are (still) fulfilling their desired functions, on the other, may prove quite challenging tasks. In this respect, the machine operator often plays a central role. Such settings and sheet metal processing means are selected based on the operator's experience and empirical values and, where available, on the specifications of the manufacturer of the sheet metal processing machine. These selections and settings are typically optimised, by way of trial and error, during several passes. The disadvantage of such an approach is that on the one hand it leads to inefficient processes and, possibly, to sub-optimal results, and, on the other hand, the process is highly dependent on the machine operator and his or her experience.

Proceeding from this, it is an object of the present invention to provide an approach for efficiently using a sheet metal processing machine in such a manner as to achieve highly optimised processing results. Both the quality of the provided sheet metal processing and the processing efficiency, in particular with respect to a required number of passes through the machine and a consumption of operating means, are to be improved.

To achieve this object, the present invention, in a first aspect, relates to a device for recognising a sheet metal processing means in a sheet metal processing machine, including:
an RFID unit for receiving a read signal of an RFID reader with information relating to an RFID transponder affixed on a sheet metal processing means at a sheet metal processing station in said sheet metal processing machine;
an evaluation unit for determining sheet metal processing means data with information on the sheet metal processing means based on said read signal; and
a machine interface for controlling a machine system of the sheet metal processing machine based on the sheet metal processing means data.

In a further aspect, the present invention relates to a system for processing sheet metal, including:
a device as described above;
a sheet metal processing machine having a machine system;
a sheet metal processing means having an RFID transponder connected therewith, in particular a wide-surface grinding belt having an RFID transponder adhered onto a rear surface facing away from the processing surface, a wheel brush, a transverse brush, a deburring roller and/or a deslagging unit; and
an RFID reader for reading out the RFID transponder when the sheet metal processing means is located at a sheet metal processing station in the sheet metal processing machine.

In a further aspect, the present invention relates to a sheet metal processing means for processing sheet metal having an RFID transponder connected therewith which is to be used in conjunction with a device as described above or in a system as described above.

Further aspects of the invention relate to a method corresponding to said device and a computer programme product having programme code for carrying out the steps of the method when the programme code is being executed on a computer, and a storage means on which a computer programme is stored which, when executed on a computer, causes the method described herein to be performed.

Preferred embodiments of the invention are described in the dependent claims. It is to be understood that the features mentioned above and those yet to be explained further down may not only be used in their respectively specified combination but also in other combinations or alone without departing thereby from the scope of the present invention. In particular, the system, the method, and the computer programme product may be designed so as to correspond to the configurations as described for the device and the system in the dependent claims.

Provision is made, according to the invention, for sheet metal processing means used in processing stations in a sheet metal processing machine to be equipped with RFID transponders. These RFID transponders are read out by RFID readers. The RFID reader may be disposed, in particular, in the sheet metal processing machine or may be disposed at some other location permitting to read out a sheet metal processing means at a sheet metal processing station in the sheet metal processing machine. In particular, the sheet metal processing means may be a grinding means which is suitable for grinding a metal sheet.

The device according to the invention may be used to receive a read signal of an RFID reader. The read signal may comprise, in particular, an ID number assigned to the sheet metal processing means. This ID number may, for example, have been issued already by the manufacturer of the sheet metal processing means, such that it is possible for the manufacturer to provide information that is specifically associated with this sheet metal processing means.

Based on the read signal, it is possible to determine sheet metal processing means data that is associated with the sheet metal processing means. For example, a database query may be performed with respect to it or a specific item of information that has previously been recorded or created for this sheet metal processing means may thus be looked up or expanded. A machine system of the sheet metal processing machine may be activated and controlled based on the sheet metal processing means data. This machine system will define, in particular, parameters for the sheet metal processing and/or will perform the sheet metal processing. Based upon the sheet metal processing means (i.e. the tool) employed, it is possible to automatically preset distances, durations, forces, orientations, etc. in order to achieve efficient and highly optimised sheet metal processing.

Unlike existing approaches lacking automated identification of the sheet metal processing means and automated control of the machine system, the inventive approach enables higher efficiency as well as improved processing quality. On the one hand, it is possible to optimise the utilisation of the sheet metal processing means so as to cause as little wear as possible while achieving rapid processing rates. On the other hand, the quality achievements may be enhanced and/or optimised, since it is possible to resort to empirical values for the sheet metal processing means and/or the specific type thereof. For example, it thus becomes possible, for various different sheet metal processing means to automatically record their performance behaviour and, based thereon, to adjust any further sheet metal processing operations accordingly. In addition, operating errors may be avoided and thus even inexperienced operators may be entrusted with machine control tasks. A utilisation of inadequate tools or sheet metal processing means or, for that matter, a utilisation of sheet metal processing means whose service lifetime has been exceeded may thus be identified and/or avoided.

The inventive solution is preferably conceived in such a manner that the sheet metal processing machine may also be operated independently of the inventive device. The availability of the sheet metal processing machine will thus not be compromised.

In a preferred configuration, the evaluation unit is designed for determining a type of the sheet metal processing means, a sheet metal processing station at which said sheet metal processing means is located, a graining of the sheet metal processing means, a predefined possible area of application of the sheet metal processing means, wear information on a wear status of the sheet metal processing means and/or on an accumulated operating time of said sheet metal processing means. In addition, or alternatively, the evaluation unit is designed for determining an individual parameter of the sheet metal processing means that has been acquired in the course of a previously performed measurement operation, in particular a width and/or a thickness of a wide-surface grinding belt that constitutes the sheet metal processing means. By determining one of the above-mentioned parameters based on the read signal, it is possible to provide additional information that may in turn be used as a basis for controlling the machine system. In other words, settings of the machine system for sheet metal processing are adjusted based on the above-mentioned parameters. It is thus possible to retrieve predefined information that is invariable over the service lifetime of the sheet metal processing means, or to acquire and/or record individualised information assigned to the specific sheet metal processing means.

A separate measurement operation and/or calibration procedure may be carried out for determining an individual parameter for the specific sheet metal processing means. Starting from a value obtained in this calibration or measurement operation, it will be possible, for example, to record the development of this value, supported, where appropriate, by further measurement operations. Monitoring this development may then be used to efficiently record and track specific information regarding this particular sheet metal processing means. When a sheet metal processing means is being changed, it is possible, in particular, by loading values and/or data obtained during a previous calibration procedure to shorten setup times as compared to a new calibration to be performed from scratch. The calibration procedure can either be performed outside the sheet metal processing machine at a dedicated calibration station or within the sheet metal processing machine.

In a preferred configuration, the device comprises a database connection to a database containing information on sheet metal processing means, in particular, a local database without an Internet connection. The evaluation unit is designed for determining sheet metal processing means data based on a database query from the database, taking into account the read signal. In addition, or alternatively, the evaluation unit is designed for storing sheet metal processing means data in the database. The database connection makes it possible for information that has been added to the sheet metal processing means to be made available. The database could be filled, for example, by a manufacturer of the sheet metal processing tool, or else by a manufacturer of the sheet metal processing machine, and it may comprise information on the sheet metal processing means itself or on its performance behaviour. Information relating to a wear status or the like may, for example, be stored therein. By retrieving the data stored in the database for an ID of an RFID transponder, such information may be made available. Provision may be made for sheet metal processing means data to be saved in the same database. Sheet metal processing means data may thus be determined even at a later point in time and may then be stored in the database for the specific sheet metal processing means. In this manner, it is possible, for example, to acquire and store an operating time or an extent of operation. The database may be directly connected with the inventive device or can be linked therewith. However, the database connection of the device may also be used to communicate with a database that is connected to the machine system of the sheet metal processing machine or is integrated into the latter. In a preferred configuration, the database connection is designed for communicating with a database of the machine system. As a result, the operation of the sheet metal processing machine may usefully be improved in terms of processing efficiency and quality of the achieved results.

In a preferred configuration, the evaluation unit is designed for determining wear information related to a wear status of the sheet metal processing means, in particular to an accumulated operating time of the sheet metal processing means. The evaluation unit is designed for comparing the wear information with a predefined maximum wear. The machine interface is preferably designed for blocking a processing procedure when the maximum wear has been reached. It is advantageous, in particular, to monitor the wear status of the sheet metal processing means. The latter may, for example, be acquired starting from an operating time or starting from determined forces or from numbers of performed operations. The wear information may thus comprise a single value on a predefined scale (for example, a percentage value or a point value) or may comprise a value without a corresponding scale. It is also possible that the wear information comprises a multidimensional type of information relating to various individual parameters. This wear information may then be compared to some adequately predefined information (e.g. to a threshold value) which has been determined, for example, during previous measurements. These measurements may have been carried out, for example, by a manufacturer of the sheet metal processing means or by a manufacturer of the sheet metal processing machine. When a maximum wear status has been reached, a blockage may be triggered in order to prevent faulty performance behaviour.

In a preferred configuration, the evaluation unit is designed for recognising whether the sheet metal processing means is a previously unknown sheet metal processing means. The machine interface is designed for initiating a wear measurement if the sheet metal processing means is a previously unknown sheet metal processing means. It is thus detected whether the sheet metal processing means present in the sheet metal processing machine was used before at some earlier point in time, and whether its read signal or ID was captured previously on another occasion. If this is not the case and the sheet metal processing means is considered as unknown, a wear measurement may be performed so as to acquire an initial state of the sheet metal processing means. The wear measurement may serve, for example, to determine wear information. This information may be stored in an appropriate database. Thus, it is possible to use various different sheet metal processing means in an efficient manner. Stored data may be used/loaded from the database so as to reduce non-productive times.

In a preferred configuration the RFID unit is designed for controlling the RFID reader to trigger an RFID read operation when a machine operator indicates consent via a machine operator interface of the sheet metal processing machine and/or when an opening/closing of an access door to the sheet metal processing station is detected, preferably based on a sensor signal of a sensor of the sheet metal processing machine. In addition, or alternatively, the RFID unit is designed for transmitting a write signal to the RFID reader instructing it to store wear information of the sheet metal processing means, in particular an accumulated operating time, on the RFID transponder. A machine operator, i.e. a person operating the machine, may thus be involved in order to achieve a defined reading out of the RFID transponder. The machine operator specifies the relevant points in time for the read operation. In addition, it is possible to provide automated readouts every time access to one of the sheet metal processing tools and/or sheet metal processing means present in the machine is detected. Usually, the sheet metal processing means present in the sheet metal processing machine are separated from the surrounding environment by a flap or a door so as to prevent accidents. A detection is carried out as to whether or not this access door or flap has been opened or closed, implying that the sheet metal processing means may potentially have been changed, and if so, a read operation will be triggered. In addition, it is possible to store or record information on the RFID transponder which is subsequently available, for further processing steps, even on other machines or even on other sheet metal processing stations. This is to say that an item of information is stored directly on the sheet metal processing means, or rather on the RFID transponder affixed thereon, and may be read out at a later point in time.

In a preferred configuration, the machine interface is designed for receiving, from the machine system, an indication concerning a sheet metal processing means loaded into said machine system. The sheet metal processing means loaded into the machine system corresponds, in particular, to a sheet metal processing means present at an earlier point in time in the sheet metal processing machine. In addition, the evaluation unit is designed for determining whether the sheet metal processing means corresponds to the sheet metal processing means currently loaded in the machine system. In addition, the machine interface is designed for controlling the machine system so as to block a processing procedure when the processing means does not correspond to the sheet metal processing means that is currently loaded in the machine system. The machine system typically needs to have information available as to which tool is present in the machine. Therefore, the machine system needs to load a given sheet metal processing means in order to adjust parameters of the processing operation accordingly. It may so happen that the loaded sheet metal processing means no longer corresponds to the sheet metal processing means that is actually present in the machine. According to the invention, it may be ascertained by comparison whether a loaded tool corresponds to an actually mounted tool. If, for example, a machine operator fails to perform an update of the machine system, such a deviation may occur. By reading out the RFID transponder of the sheet metal processing means currently present in the machine, such a situation may be avoided and/or detected. Whenever a difference is detected between the loaded sheet metal processing means and the actually mounted sheet metal processing means as indicated by the readout, an action may be triggered. The safety of the machine, the machine operator and also of the processed workpiece may thus be improved.

In a preferred configuration, the machine interface is designed for controlling a display unit of the sheet metal processing machine in order to provide the machine operator with information displayed thereon relating to the currently installed sheet metal processing means and to the sheet metal processing means loaded in the machine system whenever said sheet metal processing means does not correspond to the sheet metal processing means that is loaded in the machine system. The machine interface is preferably designed for receiving a confirmation by the machine operator to the effect that the sheet metal processing means loaded in the machine system has been replaced by the actually mounted sheet metal processing means. If it is determined that the loaded sheet metal processing means does not correspond to the currently mounted sheet metal processing means, a warning may thus be transmitted to the machine operator. Processing is set to pause while waiting for a reaction of the machine operator who needs to verify and/or confirm the replacement of the sheet metal processing means. Any damaging of the sheet metal processing machine or of the workpiece will thus be prevented. The avoidance of rejects leads to cost reductions.

In a preferred configuration, the evaluation unit is designed for determining a number of sheet metal processing means at the sheet metal processing station and for comparing the determined number to a previously known target number. The machine interface is preferably designed for controlling the machine system so as to block a processing procedure and/or for controlling a display unit of the sheet metal processing machine in order to issue information on the determined number and the target number if the determined number and the target number do not coincide. Where various different sheet metal processing machines are employed, several tools or several sheet metal processing means are provided at a single processing station. If one of these sheet metal processing means has not been mounted and thus misses, this may cause machine damage or may lead to a sub-optimal processing quality. This may be avoided, according to the invention, by comparing the actual number to the target number. The quality may thus be further improved.

In a preferred configuration, the machine interface is designed for receiving processing data from the sheet metal processing machine with information on a performed sheet metal processing operation. The evaluation unit is designed for determining the sheet metal processing means data based on these processing data. Thus, it is possible for any given operation to acquire the effects it has on the sheet metal processing means. The relevant data may be received by the machine itself. On the basis of these processing operation data (for example processing duration, applied forces, angular position displacements, etc.), the evaluation unit may then determine the sheet metal processing means data. These may then, for example, be stored again. This results in a further option for making available additional data and information about the specific sheet metal processing means.

In a preferred configuration, the RFID unit is designed for receiving the read signal of an RFID reader that is arranged on the sheet metal processing machine and is preferably located in a switch cabinet of the sheet metal processing machine. In addition, or alternatively, the RFID unit is designed for receiving the read signal of an RFID reader that is coupled to a plurality of antennas, ranging between one and three, that are arranged on respective sheet metal processing stations of the sheet metal processing machine. The RFID reader may be arranged in a switch cabinet and may be connected to one or several antennas so as to be exposed to a minimum of mechanical stress and/or to the lowest possible risk potential. This leads to a high degree of reliability.

In a preferred configuration, the machine interface is designed for controlling a display unit of the sheet metal processing machine so as to issue information to a machine operator relating to the sheet metal processing means via a machine operator interface of the sheet metal processing machine. A display unit may be, for example, a display of the sheet metal processing machine. Since communication with the inventive device is ensured via a display unit provided on the sheet metal processing machine, it is possible for the operator of the sheet metal processing machine to easily interact with the inventive device. The error potential is thus reduced.

In a preferred configuration, the device is integrated into a sheet metal processing machine, in particular into a machine system of the sheet metal processing machine. The integration of the inventive device into the sheet metal processing machine reduces error-proneness due to communication between different systems. An efficient realisation of the inventive approach is thus achieved.

In a preferred configuration of the inventive system, the machine system comprises a sheet metal processing means selector unit for determining a suggestion for a sheet metal processing means to be used based on a specification for the processing procedure to be carried out. The machine interface is designed for transmitting the sheet metal processing means data to the sheet metal processing means selector unit. The sheet metal processing means selector unit is designed for determining the suggestion based on the sheet metal processing means data. A suggestion for a setting for a processing procedure to be carried out may thus be directly selected in an automated manner. The handling of the sheet metal processing machine is thus considerably simplified. Processing errors are avoided.

In the following, the invention will be described and explained in greater detail with reference to a few selected embodiment examples and in connection with the enclosed drawings. In the drawings:

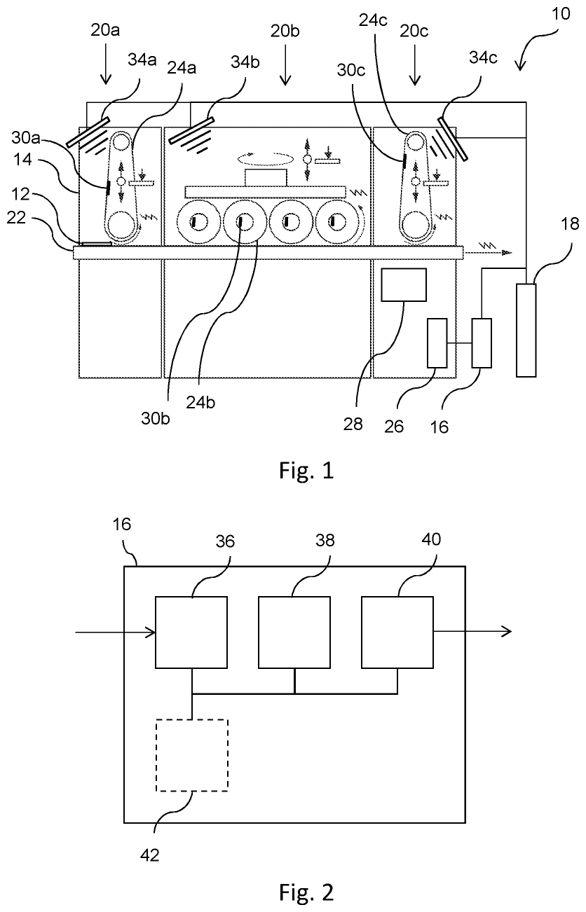

FIG. 1 is a schematic representation of a system according to the invention for sheet metal processing;

FIG. 2 is a schematic representation of a device according to the invention for recognising a sheet metal processing means in a sheet metal processing machine;

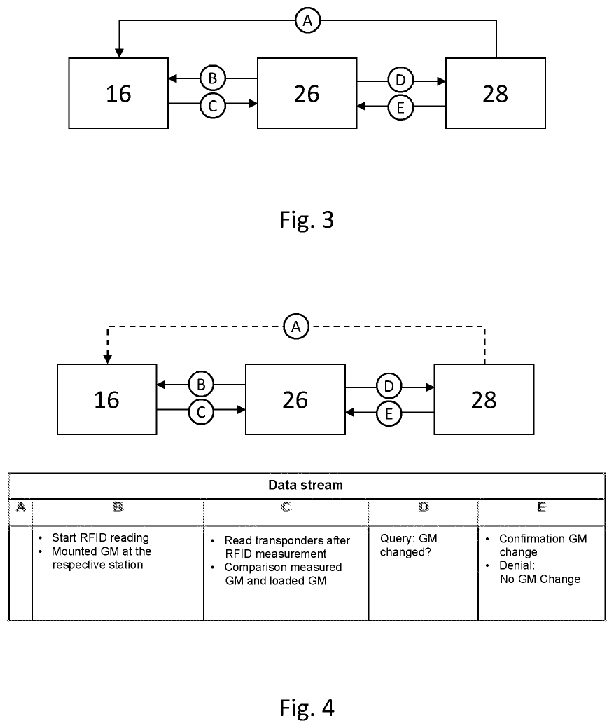

FIG. 3 shows an exemplary approach to data processing using a system according to the invention or a device according to the invention;

FIG. 4 shows another exemplary approach to data processing using a system according to the invention or a device according to the invention;

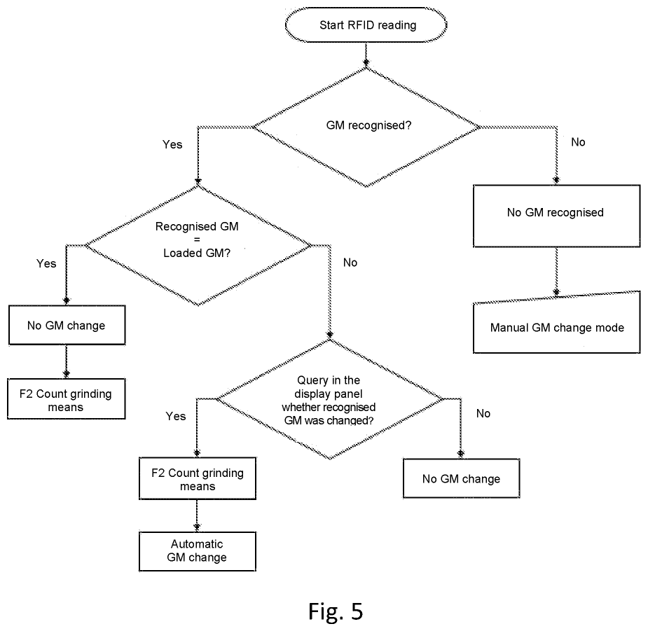

FIG. 5 shows a further exemplary approach to data processing using a system according to the invention or a device according to the invention;

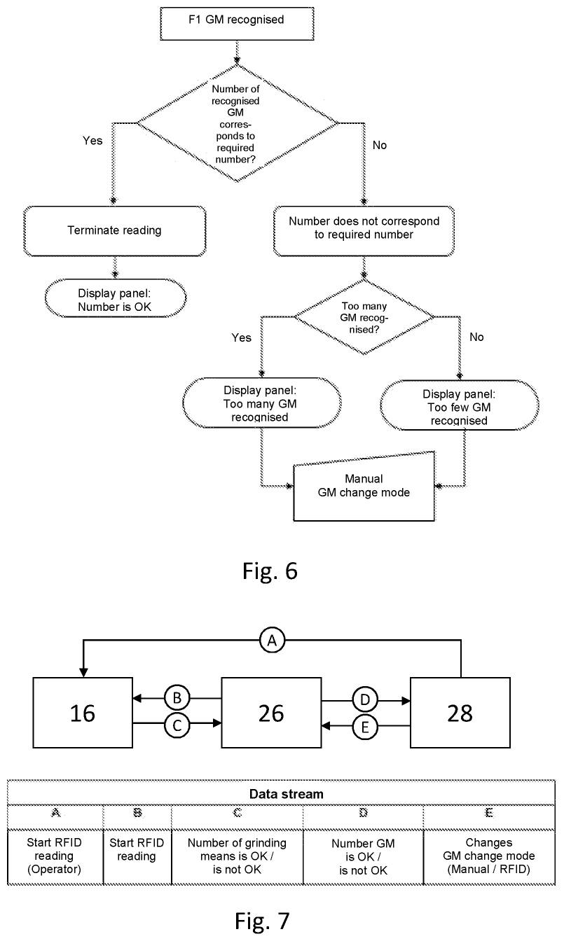

FIG. 6 shows a further exemplary approach to data processing using a system according to the invention or a device according to the invention;

FIG. 7 shows a further exemplary approach to data processing using a system according to the invention or a device according to the invention;

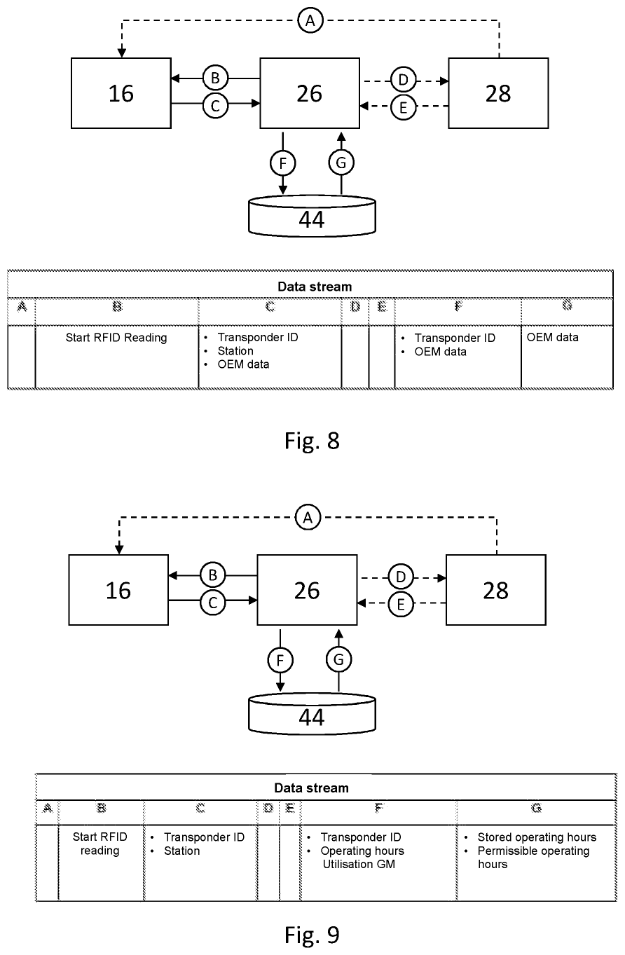

FIG. 8 shows a further exemplary approach to data processing using a system according to the invention or a device according to the invention;

FIG. 9 shows a further exemplary approach to data processing using a system according to the invention or a device according to the invention;

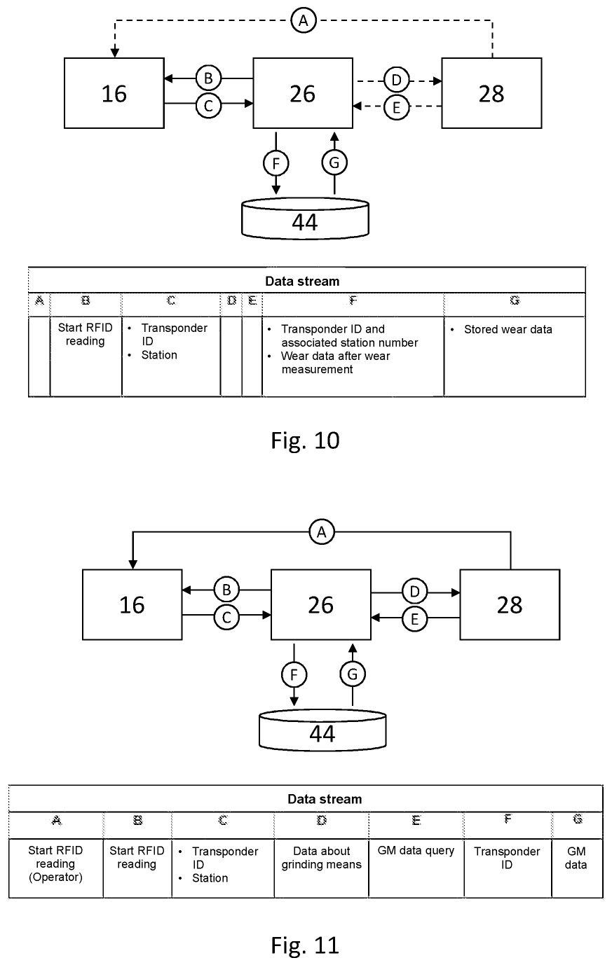

FIG. 10 shows a further exemplary approach to data processing using a system according to the invention or a device according to the invention;

FIG. 11 shows a further exemplary approach to data processing using a system according to the invention or a device according to the invention; and

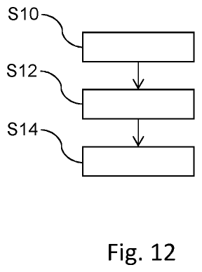

FIG. 12 is a schematic representation of a method according to the invention.

FIG. 1 schematically represents a system 10 according to the invention for processing sheet metal. The system comprises a sheet metal processing machine 14, an RFID reader 18, and a device 16 for recognising a sheet metal processing means in the sheet metal processing machine 14. In the illustrated embodiment example, the sheet metal processing machine 14 is a machine for processing relatively thick sheet metal parts made of steel or stainless steel. Three processing stations 20a, 20b, 20c are arranged along a continuous transport belt 22 in the direction of passage of the metal sheet 12. The metal sheet 12 (or workpiece) is processed successively at the sheet metal processing stations 20a, 20b, 20c. For example, the sheet metal processing machine 14 may be a deburring machine.

The first processing station 20a is designed as a grinding belt set, with the sheet metal processing means 24a being a grinding belt that rotates endlessly and is driven by an electric motor. The second processing station 20b is designed as what may be referred to as a brush set, including several grinding brushes functioning as sheet metal processing means 24b. Some of the grinding brushes, for example, may rotate around their respective horizontal axes in a co-rotating direction and some others in a counter-rotating direction. The grinding brushes may at the same time also rotate around a vertical axis. This will thus result in a multi-rotation movement of the grinding brushes. In the illustrated embodiment example, the third processing station 20c comprises a further wide-surface grinding belt functioning as a sheet metal processing means 24c. The sheet metal 12 to be processed is placed onto the transport belt 22 and passes through the sheet metal processing machine 14 from left to right, referring to the representation. First, the metal sheet is deburred by means of the first grinding belt set. The brush set is then used to round the edges and brush the surface. At the third sheet metal processing station 20c, the grinding belt set is used to precision grind the surface which thus receives a finishing.

The sheet metal processing machine 14 comprises a machine system 26, which may, in particular, constitute a machine control system and may serve for configuring and setting the performance behaviour as well as the processing procedure to be carried out. In the illustrated embodiment, the sheet metal processing machine 14 also comprises a display unit 28, which allows a machine operator to make adjustments or read out information. The machine operator usually specifies settings for the machine system 26 via the display unit 28. For this purpose, the display unit 28 may, for example, comprise a touchscreen display.

According to the invention, provision is made for the sheet metal processing means 24a, 24b, 24c to have respective RFID transponders 30a, 30b, 30c provided or attached thereon or integrated therein, which can be read out using the RFID reader 18. —In the illustrated embodiment example, the RFID reader 18 is connected, for this purpose, to a total of three antennas 34a, 34b, 34c which are arranged at the sheet metal processing stations 20a, 20b, 20c, respectively. The RFID transponders 30a, 30b, 30c are read out in the respective sheet metal processing station, with the orientation of the various antennas 34a, 34b, 34c being preferably selected such that only RFID transponders located in the respective processing stations can be read out while RFID transponders in neighbouring sheet metal processing stations are prevented from being read out accidentally.

FIG. 2 schematically represents a device 16 according to the invention for recognising a sheet metal processing means in a sheet metal processing machine. The device 16 according to the invention is used to recognise a sheet metal processing means 24a, 24b, 24c and the machine system 26 is controlled on the basis of this recognition. The device comprises an RFID unit 36, an evaluation unit 38, a machine interface 40, and an optional database connection 42. The various units may be partially or fully implemented in software and/or hardware. In particular, the units can be designed as a processor, as processor modules or in the form of software for a processor.

The device 16 may, for example, be designed in the form of an additional device for a sheet metal processing machine or in the form of software for a machine system of a sheet metal processing machine. The device 16 may, for example, be implemented in software, said software being executed on a machine system of a sheet metal processing machine. However, it is also possible for the device 16 to be designed as an additional device that communicates with a machine system, a sheet metal processing machine, and an RFID reader. Both the RFID reader and the device 16 may, for example, be arranged in a switch cabinet.

The RFID unit 36 communicates with the RFID reader and is designed for receiving a read signal. The read signal contains information about an RFID transponder located on a sheet metal processing means. Thus, the read signal may, in particular, comprise an ID of the RFID transponder.

The evaluation unit 38 is used to determine sheet metal processing means data. This determining operation is based on the previously received read signal from the RFID reader. For this purpose, the evaluation unit 38 can, for example, perform a query of a memory of the device 16, which comprises previously recorded data. It is also possible to query a database containing information on sheet metal processing means. The ID of the recognised sheet metal processing means may, for example, be used as a key for the query.

The machine interface 40 is used for communicating with the machine system of the sheet metal processing machine. In particular, the machine system is controlled based on the previously determined sheet metal processing means data. It is thus possible, for example, to control individual functions of the sheet metal processing machine (specification of a processing time, a force, a speed, etc.). It is also possible to have a current process started or interrupted or another reaction triggered.

The (optional) database connection 42 may be used to communicate with a database, which may be arranged externally or internally. For this purpose, the database connection 42 can, for example, correspond to a network connection or Internet connection, via which communication with a remotely located database can be established. For example, an Internet connection may be used to access a database of the manufacturer of the sheet metal processing machine. The database connection 42 can also address, or be in communication with, a database of the machine system.

The basic operating concept of the approach according to the invention is represented in FIG. 3. The device 16 according to the invention communicates with the machine system 26, which enables interaction with a machine operator via the display unit 28. The letters A to E characterise the various possible data streams or information flows. As indicated, a data stream A between the display unit 28 and the device 16 according to the invention can also be provided. This can be made possible, for example, by the device 16 addressing a display, possibly via the machine system 26. In the case of a processing station closed by a door or flap, a sensor can be arranged on this door or flap to detect opening/closing. This sensor can, for example, communicate with the machine system. Upon each opening/closing, the machine system can communicate with the device 16 according to the invention to initialize a measurement and/or recognition of the sheet metal processing means present in the machine.

If a newly inserted sheet metal processing means is recognised when it is inserted into the sheet metal processing machine, information determined by the device 16 according to the invention can be provided to the machine system 26. It may thus be specified, for example, at which sheet metal processing station the sheet metal processing means was inserted. It may also be specified which type of sheet metal processing means is involved and at which sheet metal processing station the change occurred. The initiation of the read-out operation may possibly involve interaction with the machine operator (for example via the display unit 28). The machine operator can, for example, be asked whether an RFID reading should be triggered.

FIGS. 4 to 11 show further possibilities for the utilisation and application of the approach according to the invention and/or for functions that can be implemented. These include, in particular, data streams A to E and/or A to G between the device 16, the machine system 26, the display unit 28, i.e. the machine operator, and the database 44. In FIGS. 4 to 11, the abbreviation GM stands for a grinding means. The approaches/functions shown in FIGS. 4 to 11 can also be used in the same way for other sheet metal processing means.

FIG. 4 schematically shows a procedure for recognising whether the correct sheet metal processing means has been inserted. The device 16 according to the invention usually has no memory of which sheet metal processing means was used at a previous point in time. Usually, only a snapshot can be taken indicating which sheet metal processing means is present in the machine at the time of measurement. The machine system 26 stores the most recently recognised sheet metal processing means or the sheet metal processing means that was supposed to be present in the sheet metal processing machine at that time. The device 16 thus receives information from the machine system 26 as to which sheet metal processing means should be in the machine and compares this information with the recognised sheet metal processing means. This comparison takes place after each new RFID readout. If the sheet metal processing means recognised by the device 16 according to the invention does not correspond to the sheet metal processing means stored in the machine system 26, a notification can be displayed on the display unit 28.

The notification can, for example, prompt the machine operator to confirm that the sheet metal processing means has been changed. For this purpose, the recognised sheet metal processing means and its parameters may, for example, be displayed to the machine operator. The machine operator can thus check whether the sheet metal processing means recognised by the device according to the invention corresponds to the sheet metal processing means that is actually present in the machine. The machine operator can then either confirm or deny that a change has taken place. In the event that such a change is not confirmed, no automatic change will take place. However, if the operator confirms the change, an automated (system-triggered) change of processing means takes place. The sheet metal processing means stored in the machine system 26 will then be replaced by the recognised sheet metal processing means.

In this context, FIG. 5 shows a schematic diagram of this approach. A verification is made as to whether or not a grinding means (functioning as a sheet metal processing means) has been changed.

FIG. 6 shows an approach for counting grinding means present in the respective sheet metal processing stations. The device according to the invention makes it possible to count the recognised sheet metal processing means and to compare the available number with a required number. This is important if, for example, several individual sheet metal processing means are used in a sheet metal processing station. Three cases in particular can be distinguished by this recognition. If more sheet metal processing means are detected than are intended for the sheet metal processing station, a warning to this effect can be issued to a machine operator. The machine operator can then be given the choice, for example, of whether the measurement should be repeated or whether a manual change of sheet metal processing means should be initiated. If fewer transponders are recognised than intended for the sheet metal processing station, the machine operator can equally be provided with information reflecting this. The detection of an insufficient number of sheet metal processing means in a sheet metal processing station either suggests that too few sheet metal processing means have been mounted. Alternatively, the RFID transponder may be defective. Furthermore, a readout may be prevented due to the presence of impurities in the sheet metal processing machine. In this case, a new measurement may, for example, be suggested to the machine operator via the display unit. If the second measurement then yields the same result, the machine operator can be prompted to check whether or not a sheet metal processing means is missing. If the number of recognised sheet metal processing means successfully matches the number of intended sheet metal processing means, this can also be displayed.

FIG. 7 illustrates the recognition of sheet metal processing means. For example, there are sheet metal processing stations or sheet metal processing machines in which several individual sheet metal processing means or a multi-part sheet metal processing means must be present in order to fully equip the sheet metal processing station and perform the desired function (see, for example, the illustration in FIG. 1 with the multi-part sheet metal processing means 20b). This may then be considered as a set of sheet metal processing means. Such a set can advantageously be regarded as a unit. All the different RFID transponders of the sheet metal processing means in a set need to be read for the unit to be considered fully complete. If one RFID transponder cannot be read, the set cannot fulfil its intended functionality. If this is recognised by the device according to the invention, a blockage can be initiated via the machine interface. For example, the set can be defined after an initial wear measurement and can be considered as a set as long as the sheet metal processing means is not blocked. Once an initial wear measurement has been carried out, the various RFID transponders that have been read can be stored as a set in a database.

As a further function, it is basically conceivable that the machine system comprises a sheet metal processing means selector unit, by which a suggestion for a sheet metal processing means to be used be can provided in a more automated manner. By interacting with the device according to the invention, it can be ensured, for example, that an intended setting of the sheet metal processing machine can only be made in a case in which the recognised sheet metal processing means corresponds to the suggested sheet metal processing means. In addition, it is also possible to use the device according to the invention to create a list that indicates which sheet metal processing means are available and for how many operating hours they have already been used (wear status indicator). It is then possible for the sheet metal processing means selector unit to suggest those sheet metal processing means that are already present and available.

FIG. 8 schematically shows an approach for storing data from the manufacturer of the sheet metal processing means on an RFID transponder. Sheet metal processing means may differ from one another in number of ways. For example, wide-surface grinding belts can differ in length due to manufacturing tolerances. This can be critical, particularly so for precision machines, as there is often no way to automatically compensate for such a difference in the sheet metal processing machine. It is possible to determine a diameter of a grinding belt using a measuring funnel. As soon as this variable is known, it can be compensated for by the machine system. Basically, it is thus possible for a length and a thickness of a wide-surface grinding belt to be determined manually (and/or individually for a given, specific sheet metal processing means) prior to delivery to the customer and to be stored on the respective RFID transponder. When the sheet metal processing means is inserted into the machine, this information can then be accessed and can be transmitted to the machine system 26 by the device 16 according to the invention. It is then possible for this information to be stored in a database 44. In the illustrated embodiment example, the database 44 is in communication with the machine system (see further data streams F and G). The database may also be in direct communication with the device 16 according to the invention. It is thus possible for any given sheet metal processing means to determine, store and/or use information specifically or individually assigned to it.

FIG. 9 schematically shows an approach for storing an operating time of the sheet metal processing means on its RFID transponder or in a database 44 having a respective transponder ID for correct assignment. The ongoing operating hours can therefore be determined by the machine system 26 and passed on to the device 16 according to the invention. This makes it possible to determine the number of accumulated operating hours of the sheet metal processing means. When a sheet metal processing means has arrived at the end of its intended service lifetime, a notification may, for example, be issued to the machine operator via the display unit 28. This notification may, for example, serve as a reminder to the machine operator to order a new sheet metal processing means. A QR code containing an appropriate order link may, for example, be integrated directly into the display. It is also possible to directly trigger an automated purchase order. In this context, it is also possible for a transponder to have a locking mechanism stored thereon which is activated when it reaches a predefined service lifetime so that the latter can no longer be used. This makes it possible to avoid hazards for the sheet metal processing machine or even for the operator.

FIG. 10 shows a further embodiment example in which wear data, for example from a wear measurement, is stored on an RFID transponder or in a database having a respective transponder ID for correct assignment. To shorten the time spent on wear measurement, the wear data obtained from the machine system need to be saved. This is of particular interest when wheel brushes are used as sheet metal processing means. By storing wear data, the time spent on wear measurement for any further refitting of the sheet metal processing means can be significantly reduced, or wear measurement may not be necessary at all.

FIG. 11 represents a schematic approach to storing data about the sheet metal processing means. For example, a type or a graining of a grinding means can be stored. A sheet metal processing means may thus be provided with a kind of electronic nameplate. Once having been read out, known data assigned to the sheet metal processing means can be made available to an operator. The readout may be performed in a sheet metal processing station in the sheet metal processing machine. Alternatively, however, provision may be made for a separate RFID antenna to be provided for this purpose. An appropriate type of application may, for example, be stored. The specified data can either be stored directly on the RFID transponder or may be obtained from a database, which is either connected directly to the device 16 according to the invention or may be made available via the machine system 26.

It is generally possible for transponder data and the associated information to be stored in a local database. This database thus lists the various RFID transponders, i.e. their IDs, that are authorised for use on a given sheet metal processing machine. In addition, these RFID transponders are blocked after having reached a predefined operating time. This local database may, for example, be updated during maintenance of the sheet metal processing machine. Alternatively, a remote, Internet-based database may also be employed for this purpose.

FIG. 12 schematically represents a method according to the invention for recognising a sheet metal processing means in a sheet metal processing machine. The method comprises the steps of receiving S10 a read signal, of determining S12 sheet metal processing means data, and of controlling S14 a machine system. The process can, for example, be implemented in software that is executed on a machine system of a sheet metal processing machine.

The invention has been comprehensively described and explained with reference to the drawings and to the description. The description and the explanation are to be understood as exemplary and not restrictive. The invention is not limited to the disclosed embodiments. Other embodiments or variations will become apparent to those skilled in the art when using the present invention and when thoroughly analysing the drawings, the disclosure and the following claims.

In the claims, the words “comprising” and “with/having” do not exclude the presence of further elements or steps. The indefinite article “a” or “an” used in connection with a word does not exclude the existence of a plurality of the items in question. A single element or a single unit can perform the functions of several of the units mentioned in the patent claims. An element, a unit, a device and a system can be partially or fully implemented in hardware and/or in software. The mere mention of some measures in several different dependent patent claims is not to be understood as meaning that a combination of these measures cannot also be used advantageously. A computer programme can be stored/distributed on a non-volatile data carrier, for example on an optical memory or on a solid-state drive (SSD). A computer programme can be distributed together with hardware and/or as part of hardware, for example via the Internet or through wired or wireless communication systems. Reference signs in the patent claims are not to be understood restrictively.

1.-15. (canceled)

16. A device for recognising a sheet metal processing means in a sheet metal processing machine, including:
an RFID unit for receiving a read signal of an RFID reader with information relating to an RFID transponder affixed on a sheet metal processing means at a sheet metal processing station in said sheet metal processing machine;
an evaluation unit for determining sheet metal processing means data with information on the sheet metal processing means based on said read signal; and
a machine interface for controlling a machine system of the sheet metal processing machine based on the sheet metal processing means data.

17. The device as claimed in claim 16, wherein the evaluation unit is designed for
determining a type of the sheet metal processing means, a sheet metal processing station at which said sheet metal processing means is located, a graining of the sheet metal processing means, a predefined possible area of application of the sheet metal processing means, wear information on a wear status of the sheet metal processing means and/or on an accumulated operating time of the sheet metal processing means; and/or
determining an individual parameter of the sheet metal processing means that has been acquired in the course of a previously performed measurement operation.

18. The device as claimed in claim 16, including a database connection to a database with information on sheet metal processing means, wherein
the evaluation unit is designed for determining sheet metal processing means data based on a database query from the database, taking into account the read signal; and/or
the evaluation unit is designed for storing sheet metal processing means data in the database.

19. The device as claimed in claim 16, wherein
the evaluation unit is designed for determining wear information related to a wear status of the sheet metal processing means; and
the evaluation unit is designed for comparing the wear information with a predefined maximum wear.

20. The device as claimed in claim 19, wherein the machine interface is designed for blocking a processing procedure when the maximum wear has been reached.

21. The device as claimed in claim 19, wherein the evaluation unit is designed for determining wear information related to an accumulated operating time of the sheet metal processing means.

22. The device as claimed in claim 16, wherein
the evaluation unit is designed for recognising whether the sheet metal processing means is a previously unknown sheet metal processing means; and
the machine interface is designed for initiating a wear measurement if the sheet metal processing means is a previously unknown sheet metal processing means.

23. The device as claimed in claim 16, wherein the RFID unit
is designed for controlling the RFID reader to trigger an RFID read operation when a machine operator indicates consent via a machine operator interface of the sheet metal processing machine and/or when an opening/closing of an access door to the sheet metal processing station is detected; and/or
is designed for transmitting a write signal to the RFID reader in order to store a wear information of the sheet metal processing means, on the RFID transponder.

24. The device as claimed in claim 23, wherein the RFID unit is designed for controlling the RFID reader to trigger an RFID read operation when a machine operator indicates consent via a machine operator interface of the sheet metal processing machine and/or when an opening/closing of an access door to the sheet metal processing station is detected based on a sensor signal of a sensor of the sheet metal processing machine.

25. The device as claimed in claim 16, wherein
the machine interface is designed for receiving, from the machine system, an indication concerning a sheet metal processing means loaded into said machine system;
the evaluation unit is designed for determining whether the sheet metal processing means corresponds to the sheet metal processing means currently loaded in the machine system; and
the machine interface is designed for controlling the machine system so as to block a processing procedure when the sheet metal processing means does not correspond to the sheet metal processing means that is currently loaded in the machine system.

26. The device as claimed in claim 25, wherein the sheet metal processing means loaded into the machine system corresponds to a sheet metal processing means present at an earlier point in time in the sheet metal processing machine.

27. The device as claimed in claim 25, wherein the machine interface is designed for
controlling a display unit of the sheet metal processing machine in order to provide the machine operator with information displayed thereon relating to the currently installed sheet metal processing means and to the sheet metal processing means loaded in the machine system whenever said sheet metal processing means does not correspond to the sheet metal processing means that is loaded in the machine system.

28. The device as claimed in claim 25, wherein the machine interface is designed for receiving a confirmation by the machine operator to the effect that the sheet metal processing means loaded in the machine system has been replaced by the actually mounted sheet metal processing means.

29. The device as claimed in claim 16, wherein
the evaluation unit is designed for determining a number of sheet metal processing means at the sheet metal processing station and for comparing the determined number to a previously known target number.

30. The device as claimed in claim 29, wherein the machine interface is designed for controlling the machine system so as to block a processing procedure and/or for controlling a display unit of the sheet metal processing machine in order to issue information on the determined number and the target number if the determined number and the target number do not coincide.

31. The device as claimed in claim 16, wherein
the machine interface is designed for receiving processing data from the sheet metal processing machine containing information on a performed sheet metal processing operation; and
the evaluation unit is designed for determining the sheet metal processing means data based on these processing data.

32. A system for processing sheet metal, including:
a device as claimed in claim 16;
a sheet metal processing machine having a machine system;
a sheet metal processing means having an RFID transponder connected therewith; and
an RFID reader for reading out the RFID transponder when the sheet metal processing means is located at a sheet metal processing station in the sheet metal processing machine.

33. The system as claimed in claim 32, wherein
the machine system comprises a sheet metal processing means selector unit for determining a suggestion for a sheet metal processing means to be used based on a specification for the processing procedure to be carried out;
the machine interface is designed for transmitting the sheet metal processing means data to the sheet metal processing means selector unit; and
the sheet metal processing means selector unit is designed for determining the suggestion based on the sheet metal processing means data.

34. A sheet metal processing means for processing sheet metal including an RFID transponder connected therewith, to be used in conjunction with a device as claimed in claim 16 or in a system for processing sheet metal, including:
the device;
a sheet metal processing machine having a machine system;
a sheet metal processing means having an RFID transponder connected therewith; and
an RFID reader for reading out the RFID transponder when the sheet metal processing means is located at a sheet metal processing station in the sheet metal processing machine.

35. A method for recognising a sheet metal processing means in a sheet metal processing machine, including the steps of:
receiving a read signal of an RFID reader with information relating to an RFID transponder affixed on a sheet metal processing means at a sheet metal processing station in said sheet metal processing machine;
determining sheet metal processing means data with information on the sheet metal processing means based on said read signal; and
controlling a machine system of the sheet metal processing machine based on the sheet metal processing means data.

36. A computer programme product including programme code for carrying out the steps of the method as claimed in claim 35 when the programme code is being executed on a computer.
